(19) United States
(12) Patent Application Publication
(10) Pub. No.: US 2010/0196652 A1
(43) Pub. Date: Aug. 5, 2010

(54) QUASI-ISOTROPIC SANDWICH STRUCTURES

(75) Inventors: Frederic Romier, Sunny Isles Beach, FL (US); Stephane Schebath, Curitiba (BR); Tim Johnson, Saint Louis, MO (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Demien Jacquinet

(21) Appl. No.: 12/698,643

(22) Filed: Feb. 2, 2010

Related U.S. Application Data
(60) Provisional application No. 61/149,497, filed on Feb. 3, 2009.

(51) Int. Cl. B32B 5/12; B32B 17/02; D05C 17/02; B32B 5/18; D05C 15/00

(52) U.S. Cl. 428/85; 428/107; 428/112; 112/475.23; 112/410

(57) ABSTRACT

A quasi-isotropic sandwich structure is provided for resisting loads along multiple axes. The structure includes a core material sandwiched by fiberglass reinforcements. Fiberglass rovings are inserted through the structure such that the rovings are oriented along three axes, with adjacent axes separated by approximately 120°. Machines and methods for forming the structures are also disclosed. In one case, a machine having a single stitch head is reconfigured in each of three passes of the material to form the sandwich structure. In other cases, a machine having three stitch heads is used to form the structure with a single pass of the material. In some embodiments, the machine includes an indexing stitch head oriented at approximately 0° and two stationary stitch heads oriented at approximately −60° and +60° with respect to the machine direction. In other embodiments, the machine includes three stationary stitch heads oriented at approximately 90°, −30°, and +30°.

### CROSS-REFERENCE TO RELATED APPLICATIONS

This application claims the benefit of U.S. Provisional Application No. 61/149,497, filed on Feb. 3, 2009, the contents of which are incorporated herein by reference in their entirety.

### BACKGROUND

Composite structures are often used in industry for building light-weight structures that require high strength and resistance to high stresses. Such composite structures may be used to construct floors, walls, and various types of large, industrial components. For example, in the aerospace industry, strong, lightweight components are important for building airplanes and other structures that must withstand high stresses without exceeding certain weight limitations. The composite components also find application as various types of panels in the boat-building industry.

Fiber reinforced sandwich structures are typically light-weight and are useful for providing load resistance. In general, such sandwich structures include a core material, such as a closed-cell foam, that is “sandwiched” on either side by sheets of fiberglass material. The layers are then attached together and impregnated with resin to form a composite panel that exhibits desirable load bearing properties along one axis of the structure. For example, in FR 2,695,864, a panel is described that includes truss-like fiber reinforcements within the panel to resist loading along an axis of the panel.

There exists a need, however, for quasi-isotropic sandwich structures that are capable of resisting loads along multiple axes and apparatuses and methods of producing such structures in an efficient and cost-effective manner.

### BRIEF SUMMARY OF THE INVENTION

The present invention generally relates to a quasi-isotropic sandwich structure for resisting loads along multiple axes. In one embodiment, the structure includes a core material sandwiched by fiberglass reinforcements. Fiberglass rovings are inserted through the structure such that the rovings are oriented along three axes, with adjacent axes separated by approximately 120°. Machines and methods for forming the structures are also disclosed. In one case, a machine having three stitch heads is used to form the structure with a single pass of the material through the machine. In some embodiments, the machine includes an indexing stitch head oriented at approximately 0° and two stationary stitch heads oriented at approximately −60° and +60° with respect to the machine direction. In other embodiments, the machine includes three stationary stitch heads oriented at approximately 90°, −30°, and +30°. In this way, a quasi-isotropic sandwich structure is produced that includes reinforcements oriented along at least three axes to provide increased resistance to flexural loading.

In one embodiment, a quasi-isotropic sandwich structure is provided that includes a core material defining a first side and a second side, a first reinforcement layer disposed on the first side of the core material, a second reinforcement layer disposed on the second side of the core material, and a first array, a second array, and a third array of rovings. Each array extends through the first reinforcement layer, the core material, and the second reinforcement layer, and the first array, the second array, and the third array of rovings are oriented along at least three axes.

The first array of rovings may be oriented at an angle of approximately 120° with respect to each of the second array and the third array, the second array of rovings may be oriented at an angle of approximately 120° with respect to each of the first array and the third array, and the third array of rovings may be oriented at an angle of approximately 120° with respect to each of the first array and the second array. The first and second reinforcement layers may be fiberglass reinforcement layers, and the rovings may be fiberglass rovings. Also, the core may be a closed cell foam in some cases.

Furthermore, the first reinforcement layer may define an insertion face, and at least one of the first array, the second array, and the third array of rovings may be oriented at an angle angle between approximately 1° and 89° with respect to a plane of the insertion face. For example, at least one of the first array, the second array, and the third array of rovings may be oriented at an angle angle between approximately 40° and 80° with respect to a plane of the insertion face, such as an angle of approximately 45° with respect to a plane of the insertion face. Each of the first array, the second array, and the third array of rovings may be tufted.

In other embodiments, a method of producing a quasi-isotropic sandwich structure is provided. According to the method, a material is advanced in a machine direction through a machine configured to insert rovings through the material. A first array of rovings is inserted through the material at a first angle, the first angle being defined in a plane of the material with respect to the machine direction, and a second array of rovings is inserted through the material at a second angle, the second angle being defined in the plane of the material with respect to the machine direction. Furthermore, a third array of rovings is inserted through the material at a third angle, the third angle being defined in the plane of the material with respect to the machine direction. The first array, the second array, and the third array of rovings are oriented along at least three axes.

The second angle may be congruent to the first angle. Also, the third array of rovings may bisect the angle formed by the first array and the second array of rovings. Each of the first array, the second array, and the third array of rovings may be inserted through the material at an angle of inclination of between approximately 1° and 89°. For example, each of the first array, the second array, and the third array of rovings may be inserted through the material at an angle of inclination of between approximately 40° and 80°, such as at an angle of inclination of approximately 45°.

In some cases, the first angle may be approximately −60°, the second angle may be approximately 60°, and the third angle may be approximately 0°. Inserting the third array of rovings may comprise inserting successive stitches at different positions of the material with respect to an axis of the material that is perpendicular to the machine axis in the plane of the material, such that the third array of rovings is indexed in a single direction. Further, inserting the third array of rovings may comprise inserting successive stitches at different positions of the material with respect to an axis of the material that is perpendicular to the machine axis in the plane of the material, such that the third array of rovings is indexed in two directions and forms a herringbone-type pattern. Inserting the first array may comprise inserting the first array in a nominal insertion direction that is opposite the machine direction, and inserting the second array may comprise inserting the second array in a nominal insertion direction that is in line with the machine direction.

In other cases, the first angle may be approximately −30°, the second angle may be approximately 30°, and the third angle may be approximately 90°. Furthermore, the material may be advanced through the machine in only a single pass.

In still other embodiments, a method of producing a quasi-isotropic sandwich structure in a single pass is provided. A tufting machine configured to tuft a material is provided, where the tufting machine includes a first stitch head oriented at a first angle, the first angle being defined in a plane of the material with respect to the machine direction, a second stitch head oriented at a second angle, the second angle being defined in the plane of the material with respect to the machine direction, and a third stitch head oriented at a third angle, the third angle being defined in the plane of the material with respect to the machine direction. The material is advanced through the tufting machine in a machine direction. In addition, a first array of rovings is inserted through the material via the first stitch head, a second array of rovings is inserted through the material via the second stitch head, and a third array of rovings is inserted through the material via the third stitch head such that the rovings are oriented along at least three axes. In some cases, the second angle is congruent to the first angle.

The first stitch head and the second stitch head may be stationary with respect to an axis of the material that is perpendicular to the machine axis in the plane of the material. The third stitch head may be configured to move with respect to the axis of the material that is perpendicular to the machine axis in the plane of the material, and the first angle may be approximately −60°, the second angle may be approximately 60°, and the third angle may be approximately 0°. The third stitch head may be configured to move in two directions with respect to the axis of the material that is perpendicular to the machine axis in the plane of the material, such that the third array of rovings forms a herringbone-type pattern.

In some cases, the first stitch head, the second stitch head, and the third stitch head may be stationary with respect to an axis of the material that is perpendicular to the machine axis in the plane of the material, and the first angle may be approximately −30°, the second angle may be approximately 30°, and the third angle may be approximately 90°. Furthermore, inserting each of the first array, the second array, and the third array of rovings may comprise inserting each of the first array, the second array, and the third array of rovings through the material at an angle of inclination between approximately 1° and 89°. For example, the first array, the second array, and the third array of rovings may be inserted through the material at an angle of inclination between approximately 40° and 80°, such as at an angle of inclination of approximately 45°.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of a sandwich structure of the prior art with truss-like reinforcements;

FIG. 2A is a schematic representation of the sandwich structure of FIG. 1 following insertion of stitches during a first pass;

FIG. 2B is a schematic representation of the sandwich structure of FIG. 1 following insertion of stitches during a second pass;

FIG. 3 is a top view of the sandwich structure of FIG. 1 showing the orientation of a needle beam;

FIG. 4 is a side view of the sandwich structure of FIG. 3 showing the angle of inclination of the needle on the stitch head;

FIG. 5A is a top view of a quasi-isotropic sandwich structure illustrating the beam orientation during a first pass according to an exemplary embodiment of the present invention;

FIG. 5B is a top perspective view of the quasi-isotropic sandwich structure of FIG. 5A illustrating the stitch orientation of the first pass according to an exemplary embodiment of the present invention;

FIG. 5C is a top view schematic representation of the quasi-isotropic sandwich structure of FIG. 5A illustrating the stitch orientation upon completion of the first pass according to an exemplary embodiment of the present invention;

FIG. 6A is a top view of the quasi-isotropic sandwich structure of FIG. 5A illustrating the beam orientation during a second pass according to an exemplary embodiment of the present invention;

FIG. 6B is a top perspective view of the quasi-isotropic sandwich structure of FIG. 6A illustrating the stitch orientation of the first and second passes according to an exemplary embodiment of the present invention;

FIG. 6C is a top view schematic representation of the quasi-isotropic sandwich structure of FIG. 6A illustrating the stitch orientation upon completion of the second pass according to an exemplary embodiment of the present invention;

FIG. 7A is a top view of a quasi-isotropic sandwich structure of FIG. 5A illustrating the beam orientation during a third pass according to an exemplary embodiment of the present invention;

FIG. 7B is a top perspective view of the quasi-isotropic sandwich structure of FIG. 7A illustrating the stitch orientation of the first, second, and third passes according to an exemplary embodiment of the present invention;

FIG. 7C is a top view schematic representation of the quasi-isotropic sandwich structure of FIG. 7A illustrating the stitch orientation upon completion of the third pass according to an exemplary embodiment of the present invention;

FIG. 8 is a top view schematic representation of a tufting machine for forming a quasi-isotropic sandwich structure according to an exemplary embodiment of the present invention;

FIG. 9 shows a close-up view of the upper face of the quasi-isotropic sandwich structure following the third pass according to an exemplary embodiment of the present invention;

FIG. 10 shows a close-up view of the lower face of the quasi-isotropic sandwich structure following the third pass according to an exemplary embodiment of the present invention;

FIG. 11 is a top view illustration of a tufting machine for forming a quasi-isotropic sandwich structure in a single pass using an indexing stitch head according to an exemplary embodiment of the present invention;

FIG. 12 is a top view illustration of the tufting machine of FIG. 14 showing the movement of the indexing stitch head according to an exemplary embodiment of the present invention;

FIG. 13 is a top view illustration of an indexing stitch head of a tufting machine for forming a quasi-isotropic sandwich structure in a single pass, where the indexing stitch head is configured to insert stitches in both indexing directions according to an exemplary embodiment of the present invention; and

FIG. 14 is a top view illustration of a tufting machine for forming a quasi-isotropic sandwich structure in a single pass using three stationary stitch heads according to an exemplary embodiment of the present invention.

### DETAILED DESCRIPTION

Embodiments of the present invention now will be described more fully hereinafter with reference to the accompanying drawings, in which some, but not all embodiments are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

Sandwich structures such as the quasi-isotropic sandwich structure of the present invention are useful for constructing floors, walls, and various types of large, industrial components. The structures typically have a low surface density and exhibit high mechanical characteristic values, which make them suitable for various applications, including applications requiring low-weight and high-strength constructions.

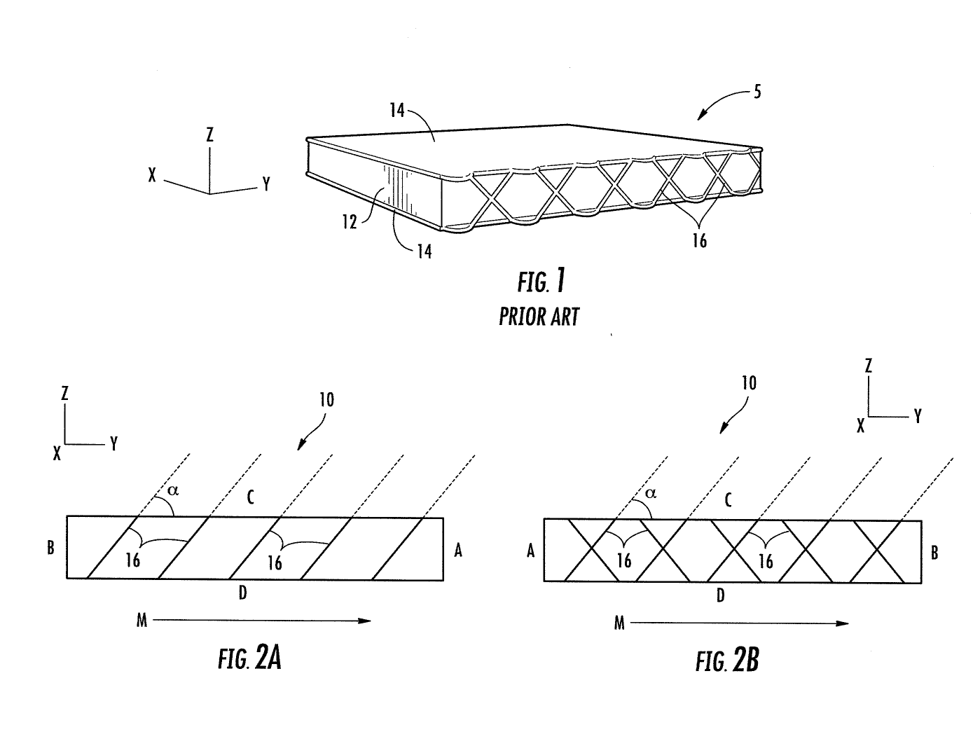

FIG. 1 shows a sandwich structure 5 of the prior art. In general, the sandwich structure 5 includes a core material 12 that is “sandwiched” by reinforcements 14 (e.g., fiberglass reinforcements) that form skin layers on two sides of the core material 12 to create a three-dimensional reinforced structure. Typically, the core material 12 is a closed-cell foam that is impervious to resin. The foam may be a rigid foam or a soft foam, depending on the application. For example, a rigid foam may be used when fabricating panels of the sandwich structure, and a soft foam may be used when the sandwich structure is to be used to form shaped objects. The reinforcements 14 are typically draped on either side of the core 12, and roving 16 is stitched through the three layers. The structure is then impregnated with thermo set resin.

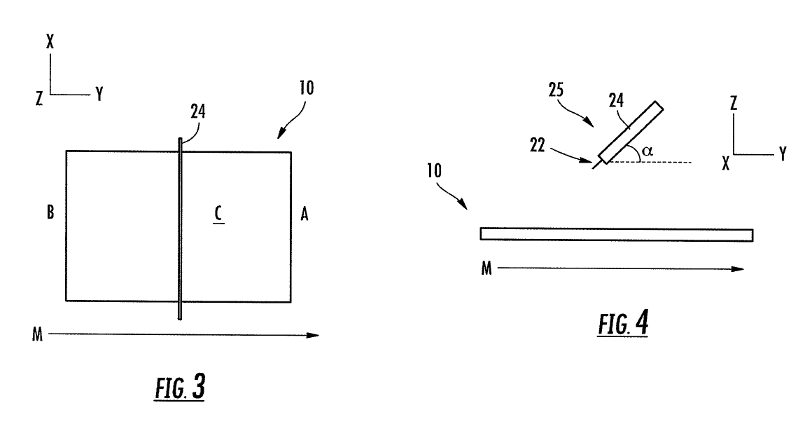

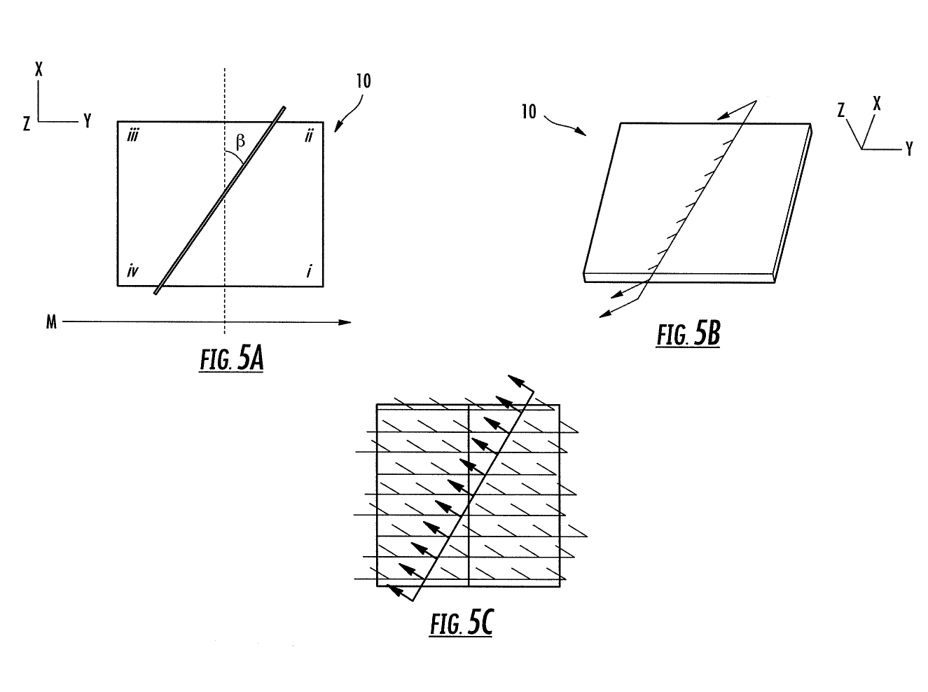

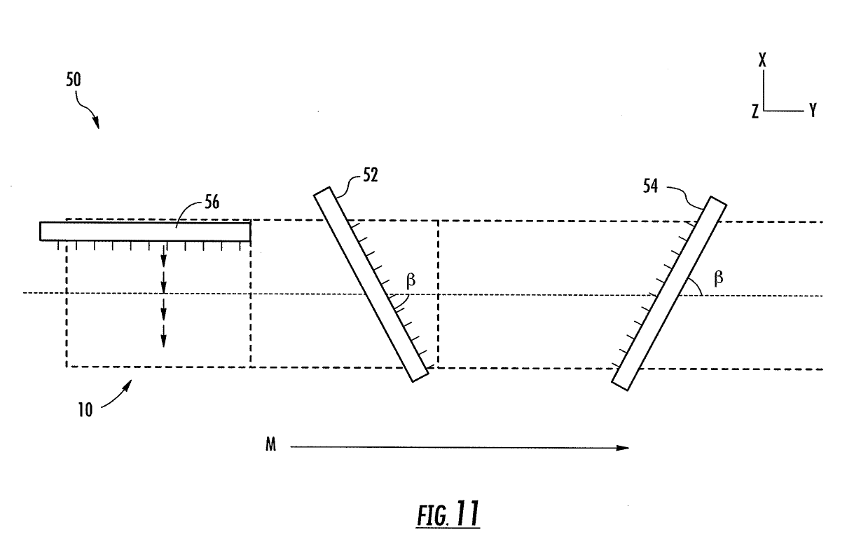

As illustrated schematically in FIG. 4, the roving 16 (e.g., fiberglass roving) may be inserted using an array of needles 22 arranged in line on a support beam 24 to form a stitch head 25 of a tufting machine 26 (shown in FIG. 8). The beam 24 may be arranged to be perpendicular to the axis of the machine, or y-axis, as shown in the top view of the structure 5 illustrated in FIG. 3. Furthermore, the needles 22 can be inclined at an angle α with respect to the plane of the structure (the x-y plane). For example, the angle α shown in FIG. 2A (which will be referred to as the angle of inclination) in some cases is approximately 45°. With reference to FIGS. 2A and 3, the material to be processed into a structure (such as the core material 12, the reinforcements 14, and/or roving 16, which are referred to below and in the figures generally as material 10) may be advanced through the stitching machine in the machine direction M during a first pass, with an end A of the material 10 as the leading end, an end B as the trailing end, a face C as the upper face, and a face D as the lower face. During the first pass, parallel rows of rovings 16 extending in the z-direction may be formed through the material. The material 10 may then be rotated 180° (such that end B of the material 10 is now leading) and passed through the apparatus a second time to insert a second set of rovings 16, as shown in FIG. 2B. As a result of the rotation of the material between FIG. 2A and FIG. 2B, the stitches of the second row are thus inserted at a negative angle of inclination with respect to the angle of the first stitches. In this way, triangulations, or truss-like reinforcements, may be formed, as illustrated in FIG. 2B.

It is notable that the described geometry of the rovings through material are a result of a tufting process, in which needles insert rovings into the material through a first face of the material, loops are created on a second, opposite face of the material, and the needles are retracted from the material through the first “insertion” face. For ease of explanation, however, the description refers to “stitching” and “stitches” in a generic sense that includes the tufting process, as understood by one of ordinary skill in the art in light of this disclosure.

Such triangulations increase the resistance of the structure 5 to flexural loads along the axis of the triangulation. Thus, for the geometry shown in FIG. 2B, the stiffness of the structure 5 is increased along the y-axis. In many cases, however, it may be desirable to provide increased resistance to flexural loading along both the y-axis and the x-axis in what will be referred to below as a quasi-isotropic structure. One way to achieve a quasi-isotropic structure would be to stitch the roving 16 such that some triangulations span the x-axis (as shown in FIG. 2B) and some triangulations span the y-axis. Achieving such a geometry would require four passes through a stitching machine—two passes in which the y-axis of the structure is aligned with the machine axis M, and two passes in which the x-axis of the structure is aligned with the machine axis M. However, twice the number of passes requires nearly twice the process cost of the original structure, which adds significantly to the cost of the product.

### Triple Pass Fabrication

In one embodiment of the present invention, a quasi-isotropic sandwich structure is produced in a manner that requires three passes through a tufting apparatus. The resulting quasi-isotropic structure includes a core material defining a first side and a second side, a first reinforcement layer disposed on the first side of the core material, a second reinforcement layer disposed on the second side of the core material, and a first array, a second array, and a third array of rovings 16 that extend through the first reinforcement layer, the core material, and the second reinforcement layer and are oriented along at least three axes. Notably, the terms “first,” “second,” and “third” as used herein do not identify the rovings or corresponding angles sequentially or temporally, but are rather used for ease of explanation. Thus, the arrays of rovings may be arranged in any order, as will be recognized by one skilled in the art in light of this disclosure.

In some embodiments, the core may be a low density foam that is a substantially closed cell structure to limit the absorption of resins so that the final structure remains low in density and the fiber network defines the principal mechanical properties. Both rigid and flexible foams, however, may be used. Other materials may also be used for the core, such as plaster. In other applications, it may be desirable to select a core material that is configured specifically to absorb resin for other reasons. Examples of rigid closed cell foams that may be used include Polyurethane, Polyisocyanurate, Phenolic, Polystyrene, and PEI. Examples of flexible closed cell foams may include Polyethylene, Polypropylene, and other hybrid thermoplastic polymer foams.

Similarly, the rovings 16 may be selected from among various different materials. Suitable materials may include any fiber type and any construction of yarns, threads, tows, etc. For example, the rovings may be mineral fibers, including fiberglass such as E-Glass and other types of glass (e.g., S, R, D, ECR, and AR). Other mineral fibers that may be used include Basalt fiber. Furthermore, synthetic materials, such as Carbon Fiber from either PAN or Pitch precursors, Aramid fibers, High Tenacity PE, PP, and PEI may also be used for the rovings, in addition to more common textile fibers of PET, PES. Although the term “roving” is most often associated with glass, the term “roving” is used herein in a more generic sense that includes tow (associated with Carbon Fiber), and yarns (including twisted, cabled, plied, and textured yarns) for all types of synthetics.

Different materials may also be used for the reinforcement layers. As described above with respect to the rovings, reinforcement layers may be produced with any of the above listed types of fibers. This may include fabric constructions of wovens or non-crimp fabrics made by stitch-bonding, as well as mats of either continuous or chopped fibers. Mats may be assembled by binders or stitch-bonding, needle punching, or hydro-entanglement.

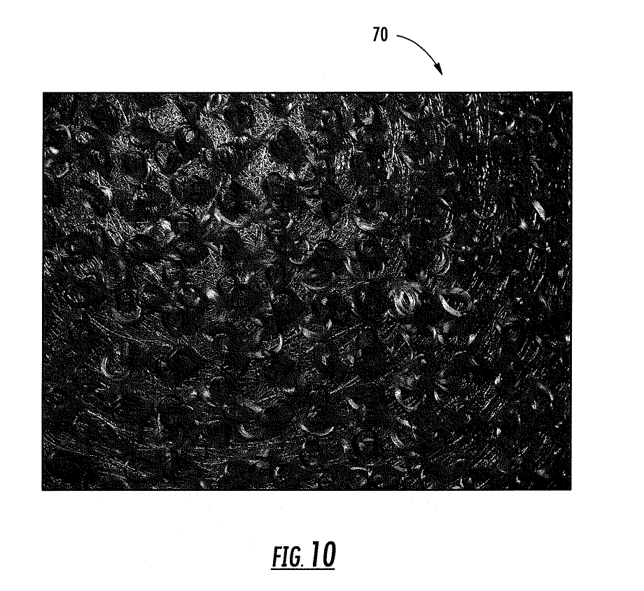

In order to achieve a quasi-isotropic structure without passing the structure through a stitching machine four times, as described above, the inventors have determined that the rovings 16 can be inserted through the structure such that the rovings 16 are oriented along at least 3 axes. To produce triangulations that are of similar proportion and number using three passes through a machine, the rovings 16 may be oriented along three different axes. For example, the three angles may be separated by 120°, as in the quasi-isotropic sandwich structure 70 shown in FIG. 7B. One embodiment for producing such triangulations in three passes is described below.

### First Pass

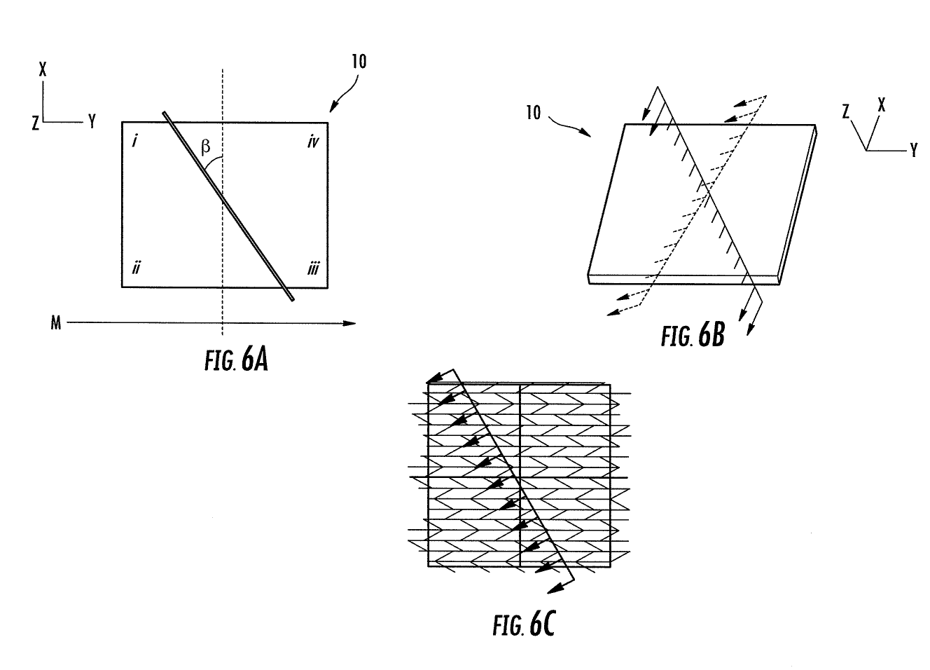

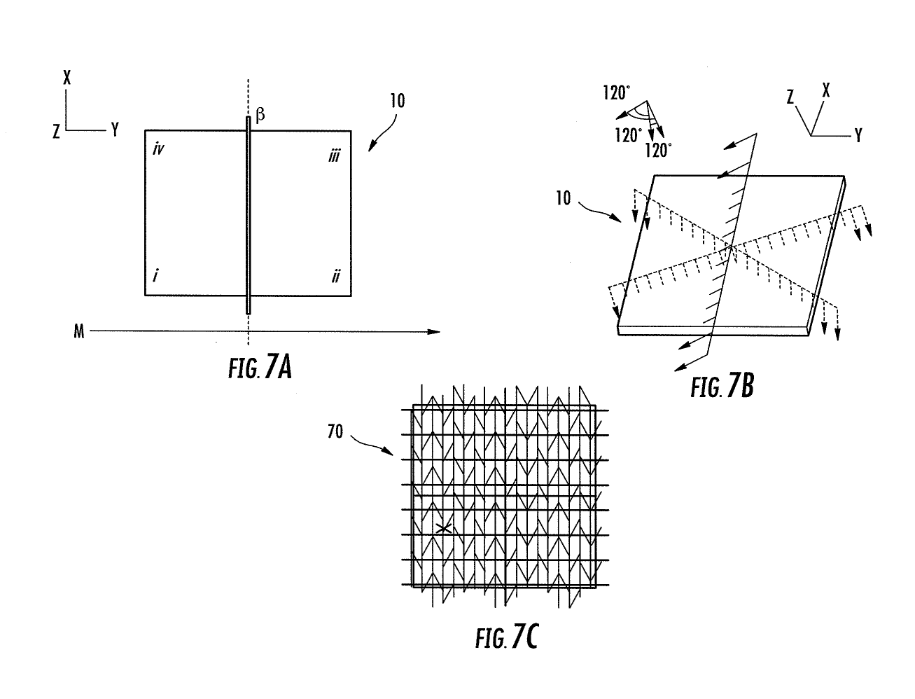

Referring to FIGS. 5A and 5B, during the first pass of the structure through the machine, the beam forming the stitch head is oriented at an angle β with respect to the x-axis, where β is approximately −30°. The angle of inclination α (shown in FIG. 2A) may be any angle between approximately 1° and 89°. For example, in some embodiments, the angle of inclination α is between approximately 40° and 80°, and in an exemplary embodiment is equal to approximately 45°. It is noted that orienting the beam 24 at an angle, such as −30°, may necessitate the addition of needles to the stitch head in order to be able to insert the rovings across the entire portion of the material spanned by the (angled) beam. As an example, a machine that typically includes 52 needles may need 8 needles added to the beam to arrive at a total of 60 needles on the stitch head. Although the specification describes the angle β as being achieved by orienting the beam 24 at an angle with respect to the x-axis, the angle β may also be achieved by positioning the needles at an angle β with respect to the x-axis while keeping the beam 24 aligned, for example, with the x-axis. In this way, both angles α and β may be achieved through appropriate positioning of the needles on the beam and the corresponding insertion motion of the beam, independent of the orientation of the beam itself.

Once the machine has been configured as described above, the material 10 may be passed through the machine, resulting in an array of stitches as illustrated in FIG. 5C.

### Second Pass

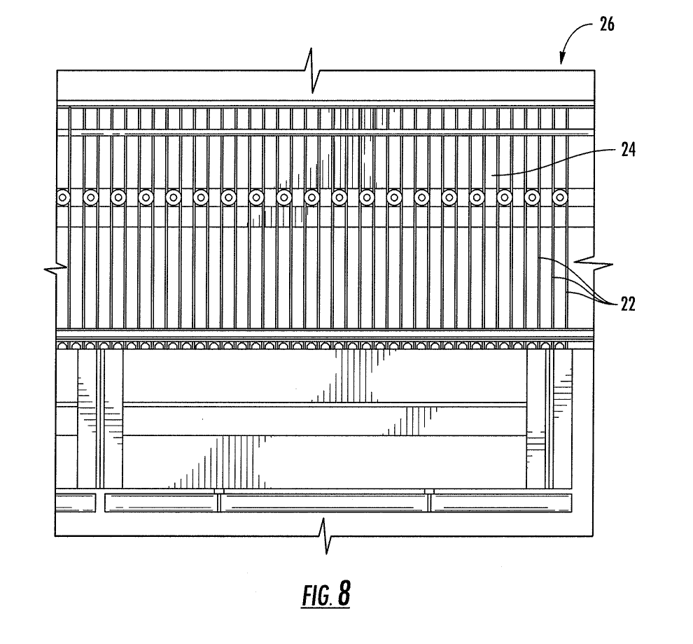

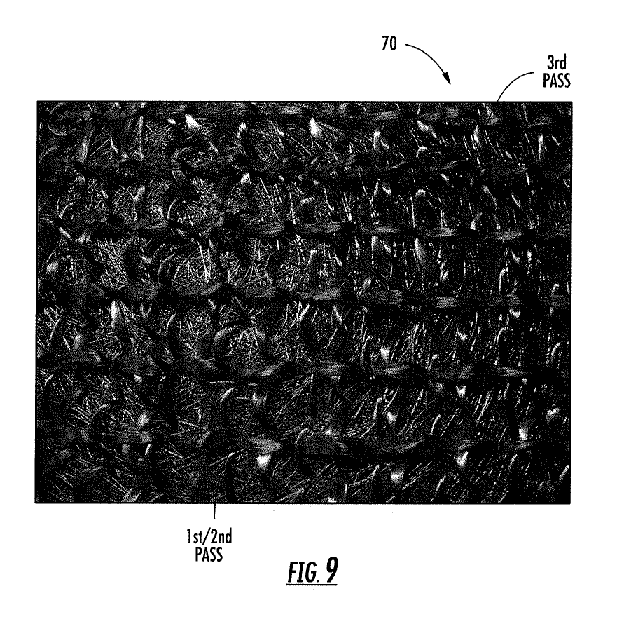

The second pass through the machine is illustrated in FIGS. 6A-6C. For the second pass, the machine is reconfigured such that the beam is oriented at an angle of approximately β=+30°, with respect to the x-axis. In addition to the re-orientation of the beam 24, the material 10 itself is rotated 180°, such that quadrant i of the structure is now located where quadrant iii once was, quadrant ii of the structure is now located where quadrant iv once was, and so on. Alternatively, the material may be rotated in the y-z plane (or “flipped over”) such that in the second pass the rovings are inserted through the opposite face of the material as compared to the insertion face used in the first pass (not shown). To facilitate the transition from each pass to the next, a mark may be made on the material (e.g., on the core material) to indicate the orientation of the material during each pass. The result of the second pass is that an array of stitches (shown in FIG. 6C) is formed in the material that is oriented at an angle of 120° from the array of stitches formed during the first pass.

### Third Pass

For the third pass through the machine (shown in FIGS. 7A-7C), the machine is once again reconfigured to change the angle β of the beam from approximately +30° with respect to the x-axis to approximately 0° (or aligned) with respect to the x-axis. Furthermore, the material 10 is rotated 90° from the previous pass, bringing quadrant i to the former location of quadrant ii and the original location of quadrant iv, etc. It is noted that during the third pass, any extra needles that may have been added to the beam 24 to configure the machine to stitch across a larger material span may be removed to accommodate the shorter span along the width of the material 10.

As shown in FIG. 7C, the array of stitches formed during the third pass serves to bisect the angle formed by the stitches of the first two passes, thereby achieving a quasi-isotropic structure after the third pass. It is noted that although, according to the description above, the beam angle β during the first pass is set at approximately −30° and for the second pass is set at approximately +30°, the beam angle β may be set at approximately +30° for the first pass and approximately −30° for the second pass. Similarly, the first, second, and third passes may occur in any order, such as the “third” pass occurring first, followed by the “first” pass and the “second” pass.

### Example

In an exemplary production run performed using the Triple Pass method described above, a machine having 52 needles (depicted in FIG. 8) was used to form a quasi-isotropic sandwich structure. To configure the machine 26 for the first pass, 8 needles 22 were added to the beam 24 in order to accommodate the larger span of the material to be stitched as a result of the re-oriented stitch head. In this example, it took one worker approximately 15 minutes to add the needles.

The stitch head was then rotated to an angle β of approximately −30°z, and the alignment of the machine was verified. In this example, it took 2 workers a total of 15 minutes to prepare the machine for the first pass once the needles had been added. The core material 12 and reinforcement layers 14 were then passed through the machine for a first pass.

Once the first pass was complete, the machine was similarly reconfigured to orient the stitch head to an angle β of approximately +30°, which took 2 workers approximately 15 minutes to accomplish. The material was rotated by 180° before being passed through the machine for the second pass.

Finally, the machine was reconfigured for the third pass by rotating the stitch head to an angle β of approximately 0°, as previously described. The additional 8 needles used for the first and second passes were also removed. Preparing the machine for the third pass took 2 workers approximately 15 minutes to accomplish. The material was rotated by another 90° between the second pass and the third pass.

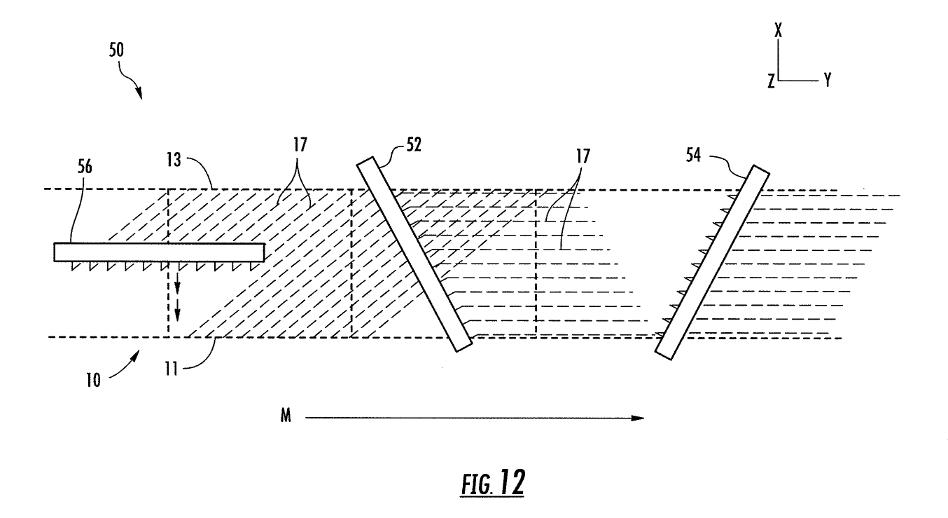

An example of a quasi-isotropic sandwich structure 70 formed according to the above example is shown in FIGS. 9 and 10, with FIG. 9 illustrating the upper face of the structure and FIG. 10 illustrating the lower face of the structure, with respect to the machine bed. In this regard, FIG. 9 shows the extension of the rovings from one insertion to the next, while FIG. 10 shows the loops created by each insertion as a result of the tufting process.

### Experimental Data

Using the Triple Pass method described above, a panel was produced using a core made of polyurethane foam having a thickness of 20 mm and a density of 35 kg/m³, fiberglass reinforcements, and thermoset polyester resin. The shear strength and modulus was measured along the principal axes (x-axis and y-axis shown in the Figures). Three samples were tested, and the results are provided in Table A below:

TABLE A

| SHEAR, MPa | Coupon | Shear Modulus | Shear Strength |
|---|---|---|---|
| Transverse | STIPX1 | 19.82 | 0.87 |
| (x-axis) | STIPX2 | 21.8 | 0.98 |
| | STIPX3 | 22.11 | 1.15 |
| | Mean | 21.2 | 1.0 |
| Longitudinal | STIPY1 | 19.45 | 0.85 |
| (y-axis) | STIPY2 | 20.29 | 0.98 |
| | STIPY3 | 18.69 | 0.88 |
| | Mean | 19.5 | 0.9 |

A second set of tests were performed on samples having substantially the same configuration, with additional shear modulus and shear strength measurements taken at 45° with respect to the y-axis in the x-y plane. The results are presented in Table B below:

TABLE B
Test 2.

| SHEAR, Mpa | Coupon | Shear Modulus | Shear Strength |
|---|---|---|---|
| Transverse | STIPX1 | 19.82 | 0.87 |
| (x-axis) | STIPX2 | 21.8 | 0.98 |
| | STIPX3 | 22.11 | 1.15 |
| | STIPX4 (36) | 14.97 | 0.65 |
| | STIPX5 (34) | 21.95 | 1.16 |
| | STIPX6 (37) | 18.14 | 0.6 |
| | STIPX7 (35) | 14.32 | 0.58 |
| | Mean | 19.0 | 0.9 |
| Longitudinal | STIPY1 | 19.45 | 0.85 |
| (y-axis) | STIPY2 | 20.29 | 0.98 |
| | STIPY3 | 18.69 | 0.88 |
| | STIPY4 (42) | 17.06 | 0.71 |
| | STIPY5 (41) | 14.99 | 0.54 |
| | STIPY6 (39) | 16.96 | 0.63 |
| | STIPY8 (38) | 16.45 | 0.6 |
| | Mean | 17.9 | 0.8 |
| Bias (45°) | STIP45-1 (44) | 17.94 | 0.6 |
| | STIP45-2 (45) | 18.54 | 0.59 |
| | STIP45-3 (46) | 17.26 | 0.51 |
| | STIP45-4 (47) | 17.12 | 0.62 |
| | STIP45-5 (48) | 17.51 | 0.66 |
| | Mean | 17.7 | 0.6 |

A panel was also formed according to the method described above using a core having a thickness of 40 mm. Additional tests were performed on samples, and those results are presented in Table C below:

TABLE C
Test 3.

| SHEAR, Mpa | Coupon | Shear Modulus | Shear Strength |
|---|---|---|---|
| Transverse | ISO40-X1 (13) | 16.03 | 0.54 |
| (x-axis) | ISO40-X2 (10) | 16.1 | 0.49 |
| | ISO40-X3 (11) | 17.54 | 0.52 |
| | ISO40-X4 (12) | 14.26 | 0.5 |
| | ISO40-X5 (9) | 17.8 | 0.52 |
| | Mean | 16.6 | 0.5 |
| Longitudinal | ISO40-Y1 (16) | 17.43 | 0.56 |
| (y-axis) | ISO40-Y2 (15) | 19.74 | 0.55 |
| | ISO40-Y3 (17) | 20.31 | 0.62 |
| | ISO40-Y4 (14) | 19.75 | 0.59 |
| | ISO40-Y5 (18) | 19.28 | 0.55 |
| | Mean | 19.2 | 0.6 |
| Bias (45°) | ISO40-45-1 (7) | 19.17 | 0.55 |
| | ISO40-45-1 (6) | 17.93 | 0.5 |
| | ISO40-45-1 (4) | 19.9 | 0.52 |
| | ISO40-45-1 (8) | 18.75 | 0.55 |
| | ISO40-45-1 (5) | 18.8 | 0.51 |
| | Mean | 18.9 | 0.5 |

### Single Pass Fabrication

In other embodiments, a tufting machine having three stitch heads may be used to form a quasi-isotropic sandwich structure in a single pass of the material. In this way, a quasi-isotropic sandwich structure can be produced without the need to reconfigure the machine between passes or to handle/rotate the material, resulting in both cost and time savings.

### Indexing Stitch Head

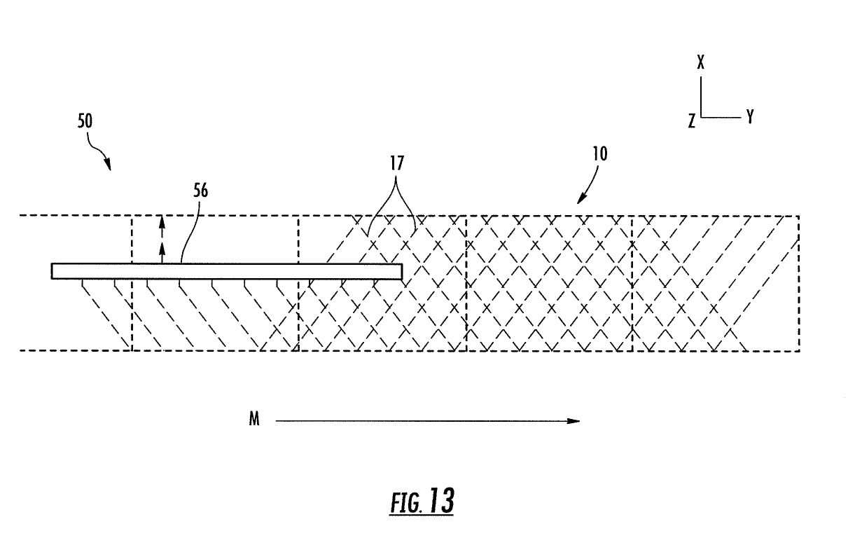

According to some embodiments, illustrated in FIGS. 11-13, the tufting machine 50 includes two stationary stitch heads 52, 54 and one indexing stitch head 56. The stationary stitch heads 52, 54 are stationary in the sense that they do not move with respect to y-axis or the x-axis, but only move in the insertion direction (i.e., to insert the stitches). The indexing stitch head 56, on the other hand, is configured to move along the x-axis in addition to moving in the insertion direction, as described below. The three stitch heads may be arranged in line in any order, such as with the indexing stitch head 56 positioned first, second, or third in the line (with respect to the movement of the material in the M-direction). In a preferred embodiment, shown in FIG. 11, the stitch heads are arranged in line along the machine direction M such that a structure passing through the machine 50 would encounter first the indexing stitch head 56, then each of the stationary stitch heads 52, 54.

Turning first to the stationary stitch heads 52, 54, a first stationary stitch head 52 is oriented such that the beam angle β formed between the stitch head 52 and the y-axis is approximately −60°. The nominal insertion direction (i.e., the component of the insertion direction that is along the y-axis) in the case of the first stationary stitch head 52 is opposite the M-direction, as indicated by the short lines representing needles along the stationary stitch head 52.

The second stationary stitch head 54 is oriented such that the beam angle β formed between the stitch head and the y-axis is approximately +60°. The nominal insertion direction of the second stationary stitch head 54 is in line with the M-direction, as indicated by the short lines representing needles along the second stationary stitch head 54. It is understood that the stationary stitch heads 52, 54 are referred to above as first and second stationary stitch heads solely for ease of explanation. The designation of the stitch heads as first or second stitch heads does not indicate a requirement that a particular stitch head be placed in a certain position with respect to the other stitch heads.

The indexing stitch head 56 is oriented such that the beam angle β formed between the stitch head and the y-axis is approximately 0°. In each of the stitch heads 52, 54, 56, the needles are angled with respect to the x-y plane of the material, and the angle may affect the performance of the composite panel. For example, the angle of inclination α (shown in FIGS. 2A and 2B) may be approximately 45° to maximize the shear modulus of the composite panel.

Because the indexing stitch head 56 is aligned with the movement of the material through the machine (i.e., the M-direction), successive insertions by the indexing stitch head 56 without corresponding movement in the x-axis direction (i.e., a hypothetical “stationary” indexing stitch head) would result in a line of overlapping stitches in the M-direction. Thus, as mentioned above, the indexing stitch head 56 is configured to move in the x-axis direction in an “indexing” type of movement to compensate for the advancement of the material through the machine, as illustrated in FIG. 12. In FIG. 12, the material 10 is shown as having passed through the indexing stitch head 56, the first stationary stitch head 52, and the second stationary stitch head 54.

For each insertion cycle, one line of tufting is created with the insertion points aligned with the y-axis. As the material is advanced to perform the next stitch cycle, the indexing stitch head 56 is configured to move along the x-axis from one edge of the material to the other. In some embodiments, the spacing of the needles on the indexing stitch head 56 corresponds with the step length imposed by the material movement in the M-direction. Thus, an appropriate number of needles to be used on the indexing stitch head 56 can be determined by considering both the extent of indexing movement and the spacing of the needles.

In some embodiments, the indexing stitch head 56 may progress step by step from one side of the material to the other, such as from “top” to “bottom” as shown in FIGS. 11 and 12. In other words, the indexing stitch head may insert stitches at different positions of the material with respect to an axis of the material that is perpendicular to the machine axis in the plane of the material (i.e., the x-axis). With reference to FIG. 12, when the indexing stitch head reaches the “bottom” (or right side 11 of the material, when viewed by a person looking at the material 10 in the machine direction M), the indexing stitch head 56 is configured to move back to its starting position at the “top” of FIG. 12, or the left side 13 of the material. Through coordination of the indexing steps with the number and spacing of the needles, the machine can be configured such that the material moves in the machine direction M a distance equal to the length of the stitch bar plus one needle. In this way, the stitch cycle may be started again without overlap (i.e., without inserting a stitch in the same location of the last stitch in the “topmost” stitch line).

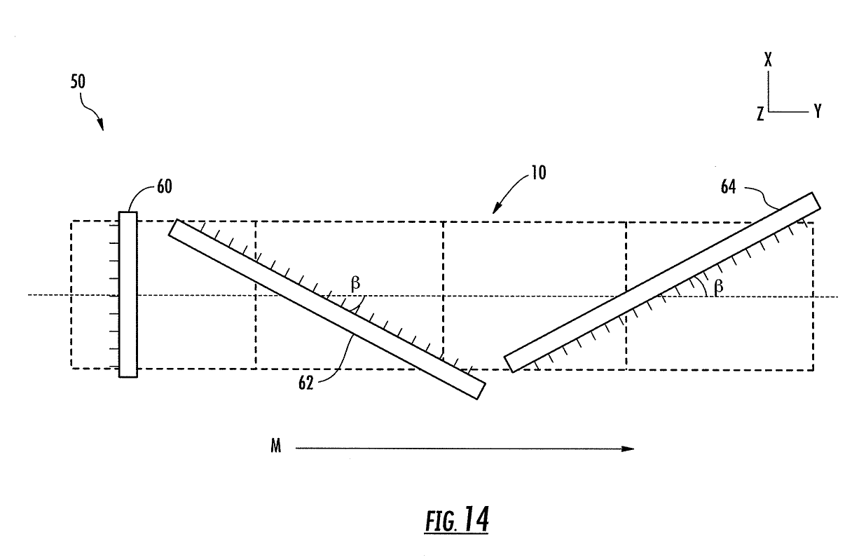

In some cases, the indexing stitch head 56 is configured such that the support beam for the needles is twice the length of the beam described above and the needles are double-spaced, as shown in FIG. 13. In this way, the machine 50 may be configured such that the indexing stitch head 56 inserts stitches in both indexing directions. Thus, the indexing stitch head 56 would insert stitches when moving from one side to the other (e.g., from the left side 13 of the material to the right side 11 of the material) and would also insert stitches when moving back to the original side (e.g., from the right side 11 back to the left side 13). Insertion in both indexing directions creates a herringbone-type pattern in the material rather than a singular diagonal pattern, as illustrated in FIG. 13 (in which the stationary stitch heads 52, 54 are removed for clarity). Inserting stitches in both indexing directions saves time as it is not necessary to wait for the machine to reset to the starting position. Furthermore, the insertion fibers between stitches do not have to be drawn across the entire width of the machine, as they would be in the previously described uni-directional tufting configuration, creating a more satisfactory and aesthetically pleasing product.

### Non-Indexing Stitch Head

In other embodiments, the machine 50 for forming a quasi-isotropic sandwich structure in a single pass of the material is configured such that an indexing stitch head is not required. According to one embodiment, and with reference to FIG. 14, the tufting machine includes three stationary stitch heads 60, 62, 64, with a first stitch head 60 aligned with the x-axis (i.e., orthogonal to the machine direction M), and the second and third stitch heads 62, 64 oriented such that the beam angle β formed between the stitch head and the y-axis is approximately −30° and +30°, respectively. The second and third stitch heads 62, 64 in this case require a longer support beam than in other embodiments due to the obliqueness of the angle β, and thus a greater number of needles may be required to span the beam-length of material. However, the fact that all three stitch heads in this embodiment are stationary reduces the complexity of the stitching machine without sacrificing the production cost and production time benefits of forming a quasi-isotropic sandwich structure in a single pass.

As with previous embodiments, it is understood that the stitch heads 60, 62, 64 are referred to above as first, second, and third stitch heads solely for ease of explanation. The designation of the stitch heads as first, second, or third stitch heads does not indicate a requirement that a particular stitch head be placed in a certain position in the line of stitch heads, and in fact the stitch heads may be arranged in any order along the machine.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

For example, variations in the angles α and β with respect to the embodiments described above are possible and contemplated by this disclosure. Variations in the angle β may in fact be used to create properties within the sandwich structure 70 that marginally favor one direction or another, as required by the user. In addition, the type and/or quantity of the rovings inserted along each production axis, among other machine settings, may be varied in order to produce structures having unique properties or characteristics. Thus, it is understood that specific angles, lengths, settings, and other values described above are provided for illustrative purposes and do not necessarily represent limitations of embodiments of the invention.

What is claimed is:

1. A quasi-isotropic sandwich structure comprising:
a core material defining a first side and a second side;
a first reinforcement layer disposed on the first side of the core material;
a second reinforcement layer disposed on the second side of the core material; and
a first array, a second array, and a third array of rovings, each array extending through the first reinforcement layer, the core material, and the second reinforcement layer,
wherein the first array, the second array, and the third array of rovings are oriented along at least three axes.

2. The sandwich structure of claim 1, wherein the first array of rovings is oriented at an angle of approximately 120° with respect to each of the second array and the third array, the second array of rovings is oriented at an angle of approximately 120° with respect to each of the first array and the third array, and the third array of rovings is oriented at an angle of approximately 120° with respect to each of the first array and the second array.

3. The sandwich structure of claim 1, wherein the first and second reinforcement layers are fiberglass reinforcement layers.

4. The sandwich structure of claim 1, wherein the core is a closed cell foam.

5. The sandwich structure of claim 1, wherein the rovings are fiberglass rovings.

6. The sandwich structure of claim 1, wherein the first reinforcement layer defines an insertion face, and wherein at least one of the first array, the second array, and the third array of rovings is oriented at an angle between approximately 1° and 89° with respect to a plane of the insertion face.

7. The sandwich structure of claim 6, wherein the first reinforcement layer defines an insertion face, and wherein at least one of the first array, the second array, and the third array of rovings is oriented at an angle between approximately 40° and 80° with respect to a plane of the insertion face.

8. The sandwich structure of claim 6, wherein the first reinforcement layer defines an insertion face, and wherein at least one of the first array, the second array, and the third array of rovings is oriented at an angle of approximately 45° with respect to a plane of the insertion face.

9. The sandwich structure of claim 1, wherein each of the first array, the second array, and the third array of rovings is tufted.

10. A method of producing a quasi-isotropic sandwich structure comprising:
advancing a material, in a machine direction, through a machine configured to insert rovings through the material;
inserting a first array of rovings through the material at a first angle, the first angle being defined in a plane of the material with respect to the machine direction;
inserting a second array of rovings through the material at a second angle, the second angle being defined in the plane of the material with respect to the machine direction; and
inserting a third array of rovings through the material at a third angle, the third angle being defined in the plane of the material with respect to the machine direction,
wherein the first array, the second array, and the third array of rovings are oriented along at least three axes.

11. The method of claim 10, wherein the second angle is congruent to the first angle.

12. The method of claim 10, wherein the third array of rovings bisects the angle formed by the first array and the second array of rovings.

13. The sandwich structure of claim 10, wherein inserting each of the first array, the second array, and the third array of rovings comprises inserting each of the first array, the second array, and the third array of rovings through the material at an angle of inclination between approximately 1° and 89°.

14. The sandwich structure of claim 13, wherein inserting each of the first array, the second array, and the third array of rovings comprises inserting each of the first array, the second array, and the third array of rovings through the material at an angle of inclination between approximately 40° and 80°.

15. The method of claim 13, wherein inserting each of the first array, the second array, and the third array of rovings comprises inserting each of the first array, the second array, and the third array of rovings through the material at an angle of inclination of approximately 45°.

16. The method of claim 10, wherein the first angle is approximately −60°, the second angle is approximately 60°, and the third angle is approximately 0°.

17. The method of claim 16, wherein inserting the third array of rovings comprises inserting successive stitches at different positions of the material with respect to an axis of the material that is perpendicular to the machine axis in the plane of the material, such that the third array of rovings is indexed in a single direction.

18. The method of claim 16, wherein inserting the third array of rovings comprises inserting successive stitches at different positions of the material with respect to an axis of the material that is perpendicular to the machine axis in the plane of the material, such that the third array of rovings is indexed in two directions and forms a herringbone-type pattern.

19. The method of claim 16, wherein inserting the first array comprises inserting the first array in a nominal insertion direction that is opposite the machine direction.

20. The method of claim 16, wherein inserting the second array comprises inserting the second array in a nominal insertion direction that is in line with the machine direction.

21. The method of claim 10, wherein the first angle is approximately −30°, the second angle is approximately 30°, and the third angle is approximately 90°.

22. The method of claim 10, wherein advancing the material comprises advancing the material through the machine in only a single pass.

23. A method of producing a quasi-isotropic sandwich structure in a single pass comprising:
providing a tufting machine configured to tuft a material, the tufting machine comprising:
a first stitch head oriented at a first angle, the first angle being defined in a plane of the material with respect to the machine direction;
a second stitch head oriented at a second angle, the second angle being defined in the plane of the material with respect to the machine direction; and
a third stitch head oriented at a third angle, the third angle being defined in the plane of the material with respect to the machine direction;
advancing the material through the tufting machine in a machine direction; and
inserting a first array of rovings through the material via the first stitch head, inserting a second array of rovings through the material via the second stitch head, and inserting a third array of rovings through the material via the third stitch head such that the rovings are oriented along at least three axes.

24. The method of claim 23, wherein the second angle is congruent to the first angle.

25. The method of claim 23, wherein the first stitch head and the second stitch head are stationary with respect to an axis of the material that is perpendicular to the machine axis in the plane of the material, wherein the third stitch head is configured to move with respect to the axis of the material that is perpendicular to the machine axis in the plane of the material, and wherein the first angle is approximately −60°, the second angle is approximately 60°, and the third angle is approximately 0°.

26. The method of claim 25, wherein the third stitch head is configured to move in two directions with respect to the axis of the material that is perpendicular to the machine axis in the plane of the material, such that the third array of rovings forms a herringbone-type pattern.

27. The method of claim 23, wherein the first stitch head, the second stitch head, and the third stitch head are stationary with respect to an axis of the material that is perpendicular to the machine axis in the plane of the material, and wherein the first angle is approximately −30°, the second angle is approximately 30°, and the third angle is approximately 90°.

28. The method of claim 23, wherein inserting each of the first array, the second array, and the third array of rovings comprises inserting each of the first array, the second array, and the third array of rovings through the material at an angle of inclination between approximately 1° and 89°.

29. The method of claim 28, wherein inserting each of the first array, the second array, and the third array of rovings comprises inserting each of the first array, the second array, and the third array of rovings through the material at an angle of inclination between approximately 40° and 80°.

30. The method of claim 28, wherein inserting each of the first array, the second array, and the third array of rovings comprises inserting each of the first array, the second array, and the third array of rovings through the material at an angle of inclination of approximately 45°.
